(19) United States
(12) Patent Application Publication
(10) Pub. No.: US 2010/0003968 A1
(43) Pub. Date: Jan. 7, 2010

(54) SYSTEM AND METHOD FOR CONTROLLING PUSH MESSAGES

(75) Inventor: CHIEN-HUNG CHENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/241,068

(22) Filed: Sep. 30, 2008

(30) Foreign Application Priority Data
Jul. 3, 2008 (CN) 200810302511.3

(51) Int. Cl. H04L 12/58

(52) U.S. Cl. 455/412.1

(57) ABSTRACT

A method for controlling push messages on a portable electronic device is provided. The computer-implemented method for filtering reception of push messages includes providing a pre-configured white list containing at least one IP address, receiving service indication of a push message initiated by a push initiator and forwarded by a push proxy gateway, determining if the source address contained in the service indication is on the pre-configured white list, and, if so, connecting to the push initiator to retrieve the push message.

### BACKGROUND

1. Field of the Invention

Embodiments of the present disclosure relate to control of push messages, and more particularly to a system and method for filtering reception of push messages on a portable electronic device.

2. Description of Related Art

Currently, mobile advertising is very popular because of enhancements in wireless communication. With the deployment of Global System for Mobile communication (GSM), short messages have gradually become a means to promote goods and services. Accordingly, the emergence of wireless application protocol (WAP) has provided a variety of mobile advertising possibilities, such as stock information, E-coupons, and games.

However, under the WAP Push specification, a push initiator is capable of transmitting service indications of push messages to a portable electronic device by a push proxy gateway, without authorization. Upon receiving the service indications, the portable electronic device connects to the push initiator to retrieve the push messages from the push initiator, making it possible for the portable electronic device to receive unauthorized connection requests, which results in unwanted utilization of bandwidth retrieving unrequested push messages.

Accordingly, a system and method for controlling push messages are desirable in order to overcome the limitations described.

### SUMMARY

A method for controlling push messages on a portable electronic device is provided. The computer-implemented method for filtering reception of push messages includes providing a pre-configured white list containing at least one IP address, receiving service indication of a push message initiated by a push initiator and forwarded by a push proxy gateway, determining if the source address contained in the service indication is on the pre-configured white list, and, if so, connecting to the push initiator to retrieve the push message.

Other advantages and novel features of the system and method for controlling push messages will become more apparent from the following detailed description of preferred embodiments when taken in conjunction with the accompanying drawings.

### BRIEF DESCRIPTION OF THE DRAWINGS

FIG. 1 is a system view of an embodiment of a system for controlling push messages;

FIG. 2 is a flowchart of an embodiment of a method for controlling push messages.

### DETAILED DESCRIPTION OF CERTAIN INVENTIVE EMBODIMENTS

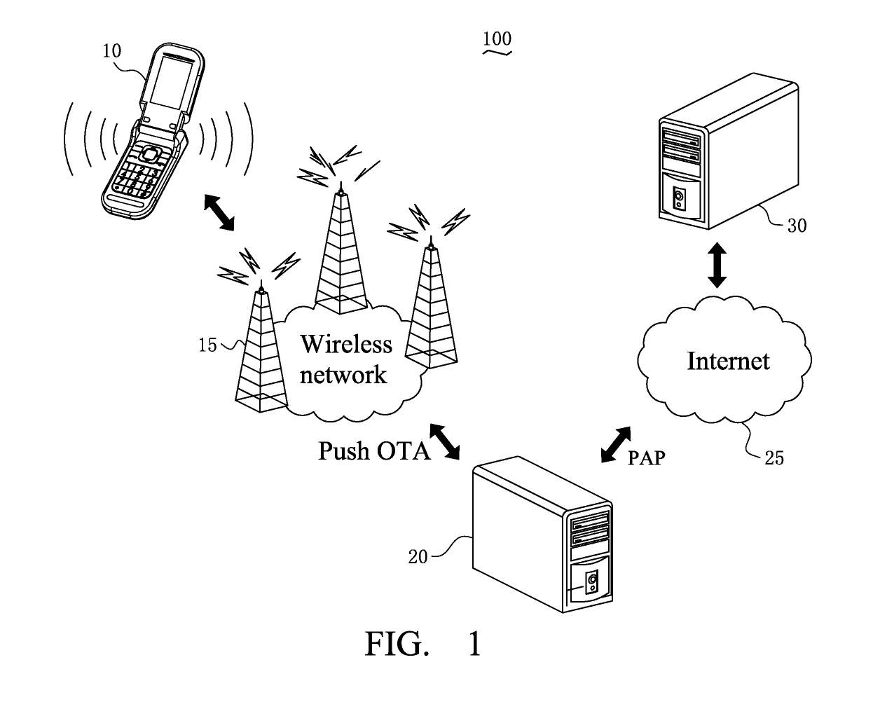

FIG. 1 is a system view of an embodiment of a system 100 for controlling push messages. The system 100 includes a portable electronic device 10, a push proxy gateway 20, and a push initiator 30. In the illustrated embodiment, the portable electronic device 10 is a mobile phone, although other electronic devices, such as notebook computers, and personal digital assistants (PDAs), for example, are equally applicable while fully maintaining the scope of the disclosure.

The push initiator 30 communicates with other servers across a network, such as the Internet 25 or a Local Area Network (LAN), to broadcast/multicast push messages, such as stock information or E-coupons, to the electronic device 10. The push initiator 30 must be in possession of an IP address for portable electronic device 10 to send the push message thereto. Push messages initiated by push initiator 30 are first forwarded to push proxy gateway 20, according to the IP address of the portable electronic device 10. While in this embodiment, the push proxy gateway 20 is set up within the Internet Service Provider (ISP) for forwarding the push message to the portable electronic device 10, in alternative embodiments, the functions of the push proxy gateway 20 and the push initiator 30 may be performed by a single server set up within the ISP sites.

Upon initiating the push message, the push initiator 30 first sends a service indication of the push message to the push proxy gateway 20 via the Internet 25, in a text format. The service indication is then routed, by push access protocol (PAP), to the push proxy gateway 20 responsible for the portable electronic device 10.

The push proxy gateway 20 is an entry point between the Internet 25 and a wireless network. Upon receiving the service indication, the push proxy gateway 20 performs necessary procedures for service indication, such as converting the service indication from the text format to a binary format. The push proxy gateway 20 then transmits the processed service indication to the portable electronic device 10 by Push over-the-air (Push OTA) located over the Wireless Session Protocol (WSP).

In an embodiment, the portable electronic device 10 sets up a pre-configured white list for authenticating source addresses of push messages indicated by the service indication following receipt thereof. If the source address indicated by the service indication is not on the pre-configured white list, the portable electronic device 10 drops the service indication directly without connecting to the push initiator 30. If the source address indicated by the service indication is on the pre-configured white list, the portable electronic device 10 connects to the push proxy gateway 20 by a WAP GET request.]

Upon receiving the WAP GET request, the push proxy gateway 20 connects to the push initiator 30 by an Hypertext Transfer Protocol (HTTP) GET request according to the hyperlink indicated by the service indication, and retrieves the push message content (hereinafter referred to as “WAP pages”).

Upon receiving the HTTP GET request, the push initiator 30 transmits the requested WAP pages in text format to the push proxy gateway 20 by an HTTP RESPONSE. The WAP pages may be encoded in Wireless Markup Language (WML).

After receiving the WAP pages, the push proxy gateway 20 converts the WAP pages from the text format to the binary format to conserve time and resources required for processing thereof. The push proxy gateway 20 transmits the WAP pages in the binary format to the portable electronic device 10 by WAP RESPONSE.

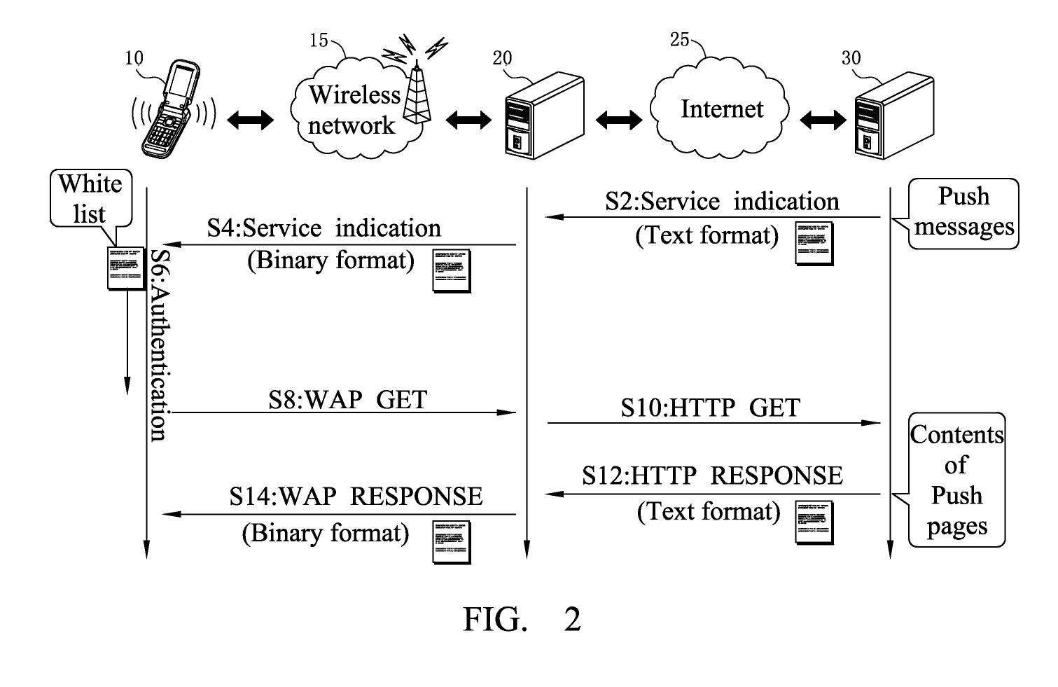

FIG. 2 is a flowchart of an embodiment of a method for controlling push messages for the system 10. The method of FIG. 2 may be used to terminate connections initiated by unauthorized push messages, utilizing a pre-configured white list. Additional blocks may be added or deleted and executed in sequences other than that described here.

In block S2, the push initiator 30 sends a service indication of a push message to the push proxy gateway 20 by PAP. The service indication is in a text format. In block S4, the push proxy gateway 20 converts the service indication to a binary format and then sends the converted service indication to the portable electronic device 10 by Push OTA. In block S6, the portable electronic device 10 checks the source address of the service indication. If the source address of the service indication is on a pre-configured white list, in block S8, the portable electronic device 10 connects to the push proxy gateway 20 by a WAP GET request. In block S10, the push proxy gateway 20 connects to the push initiator 30 by an HTTP GET request to retrieve the WAP pages of the push messages.

In block S12, the push initiator 30 transmits the requested WAP pages in the text format to the push proxy gateway 20. In block S14, the push proxy gateway 20 converts the WAP pages to a binary format and transmits the converted WAP pages to the portable electronic device 10.

In block S6, if the source address of the service indication is not on the pre-configured white list, the portable electronic device 10 drops the service indication of the push messages directly.

Understandably, in order to conserve system resources of the portable electronic device 10, the pre-configured white list may be further uploaded to the push proxy gateway 20. In this way, the push proxy gateway 20 is capable of performing the authentication performed here by the portable electronic device 10.

In addition, to reduce the number of unknown push messages, the ISP may maintain a pre-configured white list stored on the push proxy gateway 20 to block advertisement or otherwise unwanted push messages.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for controlling push messages, the system comprising:
a portable electronic device having a pre-configured white list, the pre-configured white list having at least one IP address; and
the portable electronic device configured for receiving service indication of a push message initiated by a push initiator and forwarded by a push proxy gateway for determining if a source address indicated by the service indication is on the pre-configured white list, and connecting to the push initiator to retrieve the push message if the source address indicated by the service indication is on the pre-configured white list.

2. The system as claimed in claim 1, wherein the push initiator sends the service indication in a text format to the push proxy gateway by a push access protocol.

3. The system as claimed in claim 2, wherein the push proxy gateway further converts the service indication from the text format into a binary format and sends the converted service indication by a push over-the-air protocol to the portable electronic device.

4. The system as claimed in claim 2, wherein the portable electronic device connects to the push proxy gateway by a wireless application protocol, and the push proxy gateway connects to the push initiator according to a hyperlink indicated by the service indication.

5. The system as claimed in claim 4, wherein the push initiator further transmits the push message in the text format to the push proxy gateway after the connection between the push proxy gateway and the push initiator is established.

6. The system as claimed in claim 5, wherein the push message is encoded in a wireless markup language.

7. The system as claimed in claim 6, wherein the push proxy gateway further converts the push message from the text format to the binary format, and transmits the converted push message to the portable electronic device.

8. The system as claimed in claim 1, wherein the portable electronic device further discards the service indication directly upon determining that the source address indicated by the service indication is not on the pre-configured white list.

9. The system as claimed in claim 1, wherein the pre-configured white list is maintained by the portable electronic device.

10. The system as claimed in claim 1, wherein the pre-configured white list is maintained by the push proxy gateway.

11. A computer-implemented method for controlling push messages, the method comprising:
providing a pre-configured white list in a portable electronic device, the pre-configured white list comprising at least one IP address;
receiving a service indication of a push message initiated by a push initiator and forwarded by a push proxy gateway;
determining if a source address indicated by the service indication on the pre-configured white list; and
connecting to the push initiator to retrieve the push message if the source address of the service indication is on the pre-configured white list.

12. The method as claimed in claim 11, wherein the service indication sent from the push initiator is in a text format and is sent to the push proxy gateway by a push access protocol.

13. The method as claimed in claim 12, wherein sending the service indication from the push proxy gateway to the portable electronic device comprises:
the push proxy gateway converting the service indication from the text format to a binary format; and
forwarding the converted service indication to the portable electronic device utilizing a push over-the-air protocol.

14. The method as claimed in claim 12, wherein the portable electronic device connects to the push proxy gateway by a wireless application protocol, and the push proxy gateway connects to the push initiator according to the hyperlink indicated by the service indication.

15. The method as claimed in claim 14, further comprising transmitting the push message in the text format to the push proxy gateway after connection between the push proxy gateway and the push initiator is established.

16. The method as claimed in claim 15, further comprising encoding the push message with wireless markup language.

17. The method as claimed in claim 16, further comprising:
the push proxy gateway converting the push message from the text format to the binary format; and
transmitting the converted push messages to the portable electronic device.

18. The method as claimed in claim 11, further comprising:
discarding the service indication directly upon determining that the source address indicated by the service indication is not on the pre-configured white list.

19. The method as claimed in claim 11, wherein the pre-configured white list is maintained by the portable electronic device.

20. The method as claimed in claim 11, wherein the pre-configured white list is maintained by the push proxy gateway.
